(19) United States
(12) Patent Application Publication
(10) Pub. No.: US 2025/0390755 A1
(43) Pub. Date: Dec. 25, 2025

(54) SYSTEM AND METHOD OF TRAINING A STUDENT MODEL USING A TEACHER MODEL

(71) Applicant: L&T TECHNOLOGY SERVICES LIMITED, Chennai (IN)

(72) Inventors: SUDHIR BHADAURIA, Ahmedabad (IN); VIKRAM SUBRAMANI, Krishnagiri (IN)

(21) Appl. No.: 18/939,626

(22) Filed: Nov. 7, 2024

(30) Foreign Application Priority Data
Jun. 19, 2024 (IN) 202441047254

(51) Int. Cl. G06N 3/096

(52) U.S. Cl. CPC G06N 3/096

(57) ABSTRACT

The disclosure relates to a method and system of training a student model using a teacher model. The method includes receiving, from a user, a selection of a target knowledge distillation technique, a teacher model, a student model, and one or more batches of training data. The method further includes loading the teacher model on a memory device and extracting knowledge output from the teacher model for each of the one or more batches of the training data, based on the target knowledge distillation technique, and sequentially storing extracted knowledge output in a knowledge database. The method further includes unloading the teacher model and loading the student model on the memory device, and training the student model based on ground-truth labels associated with each of the one or more batches of training data and the knowledge output corresponding to the target knowledge distillation technique.

### TECHNICAL FIELD

This disclosure relates generally to training of Machine Learning (ML) models, and in particular, to a method and a system for training a student model using a teacher model.

### BACKGROUND

Knowledge distillation is a technique in machine learning (ML) where a smaller, simpler student model is trained to mimic the behaviour of a larger, more complex teacher model. The knowledge learned by a teacher model is transferred to the student model to achieve high performance with lesser convergence time.

However, training both teacher and student models in knowledge distillation requires substantial computational resources due to the need to load both models and perform forward passes during each iteration. This can be computationally expensive. Further, the complexity and size of the teacher model adds to this computational burden. Consequently, the process significantly extends the training time, leading to increased computational costs as longer training cycles necessitate more GPU or cloud compute hours.

Therefore, there is a need for solutions for managing the above challenges, by balancing computational resources to ensure effective knowledge transfer while efficiently handling memory and processing power during training.

### SUMMARY OF THE INVENTION

In an embodiment, a method of training a student model using a teacher model is disclosed. The method may include receiving, from a user, a selection of a target knowledge distillation technique from a plurality of knowledge distillation techniques, a teacher model, a student model, and one or more batches of training data. The method may further include loading the teacher model on a memory device, and extracting knowledge output from the teacher model for each of the one or more batches of the training data, based on the target knowledge distillation technique, and sequentially storing extracted knowledge output in a knowledge database. The teacher model may be a pre-trained model. The method may further include, upon extracting, unloading the teacher model from the memory device and loading the student model on the memory device. Further, the method may include training the student model based on ground-truth labels associated with each of the one or more batches of training data and the knowledge output corresponding to the target knowledge distillation technique, by fetching the knowledge output corresponding to the target knowledge distillation technique and each of the one or more batches of training data from the knowledge database.

In another embodiment, a system for training a student model using a teacher mode is disclosed. The system may include a processor and a memory communicatively coupled to the processor. The memory stores a plurality of processor-executable instructions, which upon execution by the processor, cause the processor to receive, from a user, a selection of a target knowledge distillation technique from a plurality of knowledge distillation techniques, a teacher model, a student model, and one or more batches of training data, and load the teacher model on a memory device. The plurality of processor-executable instructions may further cause the processor to extract knowledge output from the teacher model for each of the one or more batches of the training data, based on the target knowledge distillation technique, and sequentially storing extracted knowledge output in a knowledge database, wherein the teacher model is a pre-trained model. The plurality of processor-executable instructions may further cause the processor to, upon extracting, unload the teacher model from the memory device and loading the student model on the memory device. The plurality of processor-executable instructions may further cause the processor to train the student model based on ground-truth labels associated with each of the one or more batches of training data and the knowledge output corresponding to the target knowledge distillation technique, by fetching the knowledge output corresponding to the target knowledge distillation technique and each of the one or more batches of training data from the knowledge database.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for training a student model using a teacher model, in accordance with some embodiments of the present disclosure.

FIG. 2 is a block diagram of a model training device showing one or more modules, in accordance with some embodiments.

FIG. 3 illustrates a schematic diagram of a machine learning (ML) model showing it various layers, in accordance with some embodiments of the present disclosure.

FIG. 4 is another block diagram representation of a system for training the student model using the teacher model, in accordance with some embodiments.

FIG. 5 is a flowchart of a method of training a student model using a teacher model, in accordance with some embodiments of the present disclosure.

FIG. 6 is an exemplary computing system that may be employed to implement processing functionality for various embodiments.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims. Additional illustrative embodiments are listed below.

In knowledge distillation, the goal is to transfer the knowledge learned by the teacher model to the student model, thereby achieving high performance with reduced computational resources. Using the distilled knowledge, it is possible to train the small and compact student model effectively without heavily compromising the performance of the compact model. There are three types of processes for training student and teacher models, namely offline, online, and self-distillation. One of the processes can be selected depending on whether the teacher model is modified at the same time as the student model or not. The offline distillation process uses a pre-trained teacher model is used to guide the student model. The recent advances in deep learning has made available a wide variety of pre-trained neural network models that can serve as the teacher depending on the use case.

Following types of knowledge distillation techniques are known-response-based knowledge distillation, feature-based knowledge distillation, and relation-based knowledge distillation. The response-based knowledge distillation technique focuses on transferring the knowledge using the output probabilities (soft labels) from the teacher model. The student model may be trained to match the output probabilities of the teacher model, often using a combination of cross-entropy loss with ground-truth labels and Kullback-Leibler (KL) divergence with the soft labels. The smaller student model is trained to produce similar class probabilities as a larger, pre-trained teacher model. In the feature-based knowledge distillation technique, the intermediate features (representations) learned by the teacher model are transferred to the student model. The student model is trained to match the intermediate feature representations of the teacher model, for example, using mean squared error (MSE) or other distance metrics to minimize the difference between corresponding layers. The relation-based knowledge distillation technique focuses on transferring the relational knowledge between different instances as captured by the teacher model. The student model is trained to maintain the same relationships (such as similarities or distances) between instances as the teacher model. This often involves using pairwise or triplet losses. As such, if the teacher model understands that certain pairs of images are more similar to each other than others, the student model is trained to preserve these relational patterns.

The present disclosure provides for extracting the knowledge from teacher model based corresponding to a selected knowledge distillation technique and storing it on a knowledge database. Further, the student model is trained using the knowledge database without keeping the teacher model parallelly on memory till the student model gets converged with the teacher model.

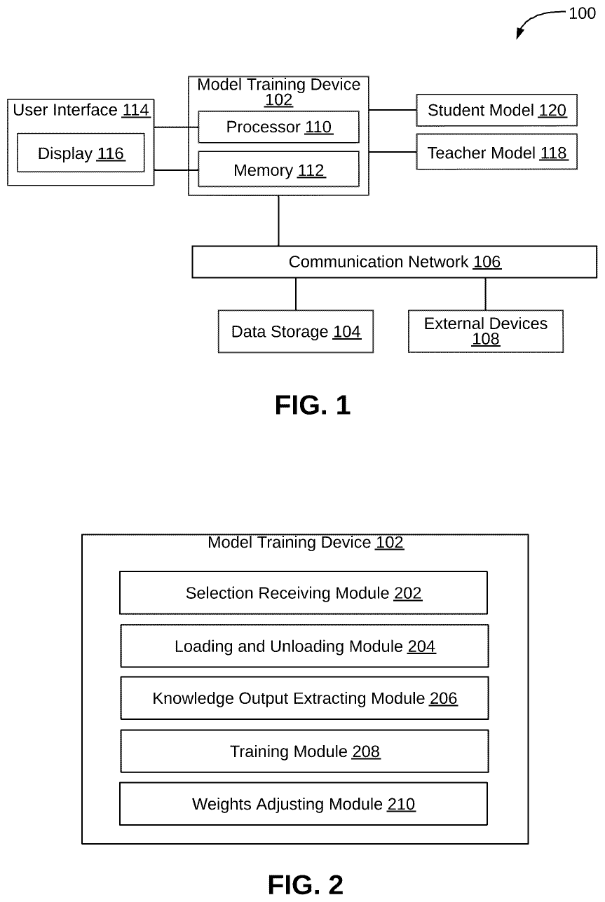

Referring now to FIG. 1, a block diagram of an exemplary system 100 for training a student model using a teacher model is illustrated, in accordance with some embodiments of the present disclosure. The system 100 may implement a model training device 102. The system 100 may further include a data storage 104. In some embodiments, the data storage 104 may store at least some of the data related to a teacher model and a student model. The model training device 102 may be a computing device having data processing capability. In particular, the model training device 102 may have the capability for training the student model using the teacher model. Examples of the model training device 102 may include, but are not limited to a desktop, a laptop, a notebook, a netbook, a tablet, a smartphone, a mobile phone, an application server, a web server, or the like.

Additionally, the model training device 102 may be communicatively coupled to an external device 108 for sending and receiving various data. Examples of the external device 108 may include, but are not limited to, a remote server, digital devices, and a computer system. The model training device 102 may connect to the external device 108 over a communication network 106. The model training device 102 may connect to external device 108 via a wired connection, for example via Universal Serial Bus (USB). A computing device, a smartphone, a mobile device, a laptop, a smartwatch, a personal digital assistant (PDA), an e-reader, and a tablet are all examples of external devices 108. For example, the communication network 106 may be a wireless network, a wired network, a cellular network, a Code Division Multiple Access (CDMA) network, a Global System for Mobile Communication (GSM) network, a Long-Term Evolution (LTE) network, a Universal Mobile Telecommunications System (UMTS) network, a Worldwide Interoperability for Microwave Access (WiMAX) network, a Dedicated Short-Range Communications (DSRC) network, a local area network, a wide area network, the Internet, satellite or any other appropriate network required for communication between the model training device 102 and the data storage 104 and the external device 108.

The model training device 102 may be configured to perform one or more functionalities that may include receiving, from a user, a selection of a target knowledge distillation technique from a plurality of knowledge distillation techniques, a teacher model 118, a student model 120, and one or more batches of training data, and loading the teacher model on a memory device. The one or more functionalities may further include extracting knowledge output from the teacher model 118 for each of the one or more batches of the training data, based on the target knowledge distillation technique, and sequentially storing extracted knowledge output in a knowledge database. The teacher model 118 may be a pre-trained model. The one or more functionalities may further include, upon extracting, unloading the teacher model 118 from the memory device and loading the student model 120 on the memory device. The one or more functionalities may further include training the student model 120 based on ground-truth labels associated with each of the one or more batches of training data and the knowledge output corresponding to the target knowledge distillation technique, by fetching the knowledge output corresponding to the target knowledge distillation technique and each of the one or more batches of training data from the knowledge database.

To perform the above functionalities, the model training device 102 may include a processor 110 and a memory 112. The memory 112 may be communicatively coupled to the processor 110. The memory 112 stores a plurality of instructions, which upon execution by the processor 110, cause the processor 110 to perform the above functionalities. The system 100 may further include a user interface 114 which may further implement a display 116. Examples may include, but are not limited to a display, keypad, microphone, audio speakers, vibrating motor, LED lights, etc. The user interface 114 may receive input from a user and also display an output of the computation performed by the model training device 102.

Referring now to FIG. 2, a block diagram of the model training device 102 showing one or more modules is illustrated, in accordance with some embodiments. In some embodiments, the model training device 102 may include a selection receiving module 202, a loading and unloading module 204, a knowledge output extracting module 206, a training module 208, and a weights adjusting module 210.

The selection receiving module 202 may be configured to receive, from a user, a selection of a target knowledge distillation technique from a plurality of knowledge distillation techniques. For example, the plurality of knowledge distillation techniques may include a response-based knowledge distillation technique, a feature-based knowledge distillation technique, and a relation-based knowledge distillation technique. The user may provide the selection, for example, via the user interface 114. To this end, in some example implementations, the user may be presented with multiple options corresponding to the response-based knowledge distillation technique, the feature-based knowledge distillation technique, and the relation-based knowledge distillation technique for the user to select from. In similar manner, the selection receiving module 202 may further receive a selection (from the user) of a teacher model, a student model, and one or more batches of training data.

The teacher model may be a pre-trained model. as will be appreciated by those skilled in the art, the teacher model may be a large, complex, and highly accurate model. The teacher model may be pre-trained on a given dataset and may be capable of achieving high performance. However, the teacher model may have a higher requirement of computational resources and time and therefore may have lower computational efficiency. Further, the teacher model may have a large number of parameters, that may allow it to capture intricate patterns in the data and deliver higher accuracy. On the other hand, the student model may be a smaller, simpler, and more efficient model that aims to replicate the performance of the teacher model. The goal is to achieve similar accuracy with reduced computational resources. As such, the student model may have fewer parameters and may be designed to be more efficient in terms of memory and computation. Although the student model may not achieve the same level of performance as the teacher model, it aims to come close, making a trade-off between accuracy and efficiency. The student model may be trained using the knowledge distilled from the teacher model, often through the use of soft labels (probabilistic outputs) provided by the teacher. Therefore, the student model may be able to provide a lightweight alternative that can be deployed in resource-constrained environments while still maintaining reasonable accuracy.

It may be noted that knowledge distillation is a process that is used to transfer knowledge from the teacher model to the student model. The knowledge distillation process aims is to achieve the student model that is more efficient in terms of computational resources while maintaining high performance. The trained teacher model may be used to generate soft labels for the training data. It should be noted that instead of only providing hard labels (i.e. actual class labels), the teacher model may output soft labels which are the probability distributions over the possible classes. As such, the knowledge distillation process helps in creating efficient models that retain high accuracy by transferring knowledge from the complex teacher model to the simpler student model.

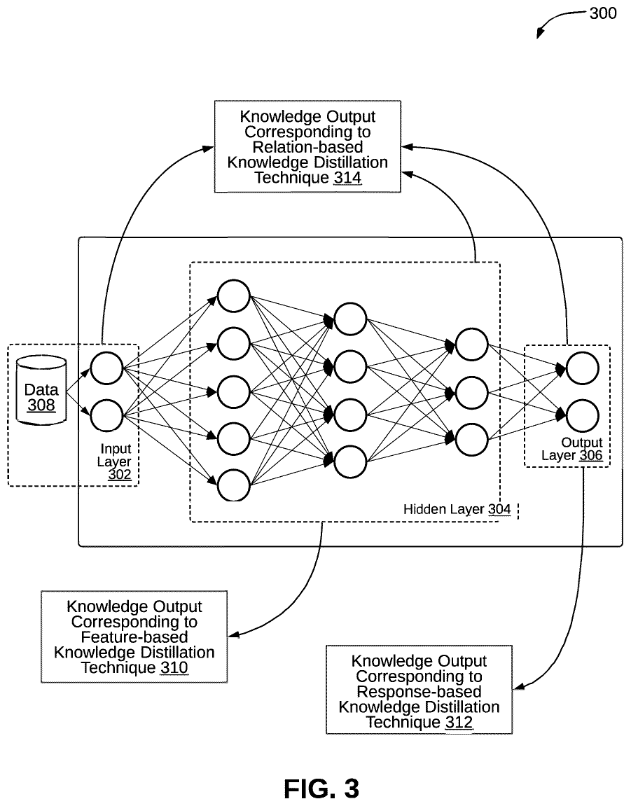

As mentioned above, the plurality of knowledge distillation techniques may include the response-based knowledge distillation technique, the feature-based knowledge distillation technique, and the relation-based knowledge distillation technique. These knowledge distillation techniques are explained in conjunction with FIG. 3.

FIG. 3 illustrates a schematic diagram of a machine learning (ML) model 300, in accordance with some embodiments of the present disclosure. The ML model 300 may incorporate an input layer 302, a hidden layer 304, and an output layer 306. The input layer 302 is the first layer of the ML model 300 where data 308 may be fed into the ML model 300. As such, the input layer 302 may serve as the entry point for the raw input features. The size of the input layer may correspond to the number of features in the dataset. The input layer 302 may be configured to pass the input data to the next layer of the network without any computation or transformation. The hidden layer 304 is an intermediate layer in the ML model 300 (or, the teacher model) and may contain intermediate feature representations that capture important information learned by the ML model 300. The output layer 306 is the final layer of the ML model 300 that produces the predictions or output of the ML model 300. It translates the processed data from the previous layers into a format suitable for the specific task.

The feature-based knowledge distillation technique involves transferring intermediate representations (features) learned by the teacher model to the student model. For example, when the teacher model has multiple hidden layers that capture different levels of abstraction in the data, the student model may be trained to replicate these intermediate features, to help the student model learn to extract meaningful representations from the input data. The student model may be trained to match the feature maps of a specific convolutional layer in a teacher model, ensuring that the student learns a similar hierarchical feature representation. Both the teacher model and the student model may extract features at various intermediate layers, for example, the hidden layer 304. The student model may be trained to match these intermediate feature representations from the teacher model. The training objective may include a loss term that measures the difference between the features of the teacher and the student models, such as mean squared error (MSE) between corresponding layers. The knowledge output corresponding to the feature-based knowledge distillation technique 310 may include internal feature representations obtained from one or more intermediate layers (i.e. hidden layer 304) of the teacher model.

The response-based knowledge distillation technique may focus on using the output layer 306 (predicted probabilities) of the teacher model to train the student model. For example, when the teacher model is a large deep neural network with high accuracy, the student model could be a smaller network that learns to mimic the teacher's output. The student model is trained to minimize the difference between its predictions and the teacher's predictions. As the teacher model is first trained on the training data to generate soft labels, these soft labels may be used as targets for the student model. The soft labels provide richer information than hard labels by indicating the teacher's confidence in each class. In some implementation, a temperature parameter may be applied to soften the teacher's probability distribution, making it easier for the student to learn. The student model may be trained using a combination of the cross-entropy loss with the hard labels and the Kullback-Leibler (KL) divergence loss with the soft labels from the teacher. A knowledge output corresponding to the response-based knowledge distillation technique 312 may include soft targets obtained from a final output layer (i.e. 306) of the teacher model.

The relation-based knowledge distillation technique focuses on transferring the relational knowledge between different instances in the dataset. This involves teaching the student model to understand how different data points relate to each other, as understood by the teacher model. In other words, in relation-based knowledge distillation technique, the goal is to transfer knowledge by capturing the relationships or dependencies between different classes in the data, to help the student model to mimic the teacher model's predictions and understand and exploit the relationships between classes in the data, leading to enhanced generalization and performance. The teacher model may capture relationships between different instances, such as pairwise distances or similarities, across the different layers, i.e. the input layer 302, the hidden layer 304, and the output layer 306. These relationships are used as additional constraints for the student model during training. The training objective includes a loss term that enforces the student model to mimic the teacher's relational knowledge, often using metrics like cosine similarity or distance metrics between feature representations of different data points. A knowledge output corresponding to the relation-based knowledge distillation technique 314 may include pair-wise relations and group-wise relations between data points obtained from the teacher model.

The knowledge output extracting module 206 may extract knowledge output from the teacher model for each of the one or more batches of the training data, based on the target knowledge distillation technique. Further, the knowledge output extracting module 206 may sequentially store extracted knowledge output in a knowledge database. In some implementations, the knowledge output corresponding to the response-based knowledge distillation technique may include soft targets obtained from a final output layer (i.e. 306) of the teacher model. The knowledge output corresponding to the feature-based knowledge distillation technique may include internal feature representations obtained from one or more intermediate layers (i.e. hidden layer 304) of the teacher model.

Referring once again to FIG. 2, once the selections of the target knowledge distillation technique, the teacher model, the student model, and the one or more batches of training data are received, the loading and unloading module 204 may load the teacher model on a memory device. It should be noted that the memory device may include a server or a cloud network. Once the selection of the teacher model is received, the loading and unloading module 204 may load the selected teacher model on the memory device.

The knowledge output extracting module 206 may extract knowledge output from the teacher model for each of the one or more batches of the training data, based on the target knowledge distillation technique. Further, the knowledge output extracting module 206 may sequentially store extracted knowledge output in a knowledge database. As mentioned above, the knowledge output corresponding to the response-based knowledge distillation technique may include soft targets obtained from a final output layer (i.e. 306) of the teacher model; the knowledge output corresponding to the feature-based knowledge distillation technique may include internal feature representations obtained from one or more intermediate layers (i.e. hidden layer 304) of the teacher model; and the knowledge output corresponding to the relation-based knowledge distillation technique may include pair-wise relations and group-wise relations between data points obtained from the teacher model.

Once the knowledge output is extracted from the teacher model for each of the one or more batches of the training data, the loading and unloading module 204 may unloading the teacher model from the memory device, and load the student model on the memory device. In other words, the teacher model and the student model are loaded sequentially and not simultaneously on the memory device. As a result, the computational resources requirement is reduced.

The training module 208 may then train the student model based on ground-truth labels associated with each of the one or more batches of training data and the knowledge output corresponding to the target knowledge distillation technique, by fetching the knowledge output corresponding to the target knowledge distillation technique and each of the one or more batches of training data from the knowledge database. The ground-truth labels are the actual, true labels of data points in the one or more batches of training data. The ground-truth labels are critical for supervised learning tasks, as they are assumed to be accurate and correctly represent the real-world outcomes or categories for the data points. During training, ground-truth labels may be used to calculate the loss (or error) of the model's predictions, which guides the learning process through optimization techniques like gradient descent. For example, during image classification pertaining to a dataset of animal images, the ground-truth label for each image might be the type of animal (e.g., “cat,” “dog,” “elephant”). As such, the ground-truth labels may be used to train a model to correctly classify new images.

In some implementations, the training module 208 train the student model by iteratively inputting each of the one or more batches of training data to the student model based on a predefined epoch. The predefined epoch may be fed to the training device as part of training configuration.

The weights adjusting module 210 may be configured to adjust weights of the student model, based on the distillation loss for the selected knowledge distillation technique. Therefore, when the selected knowledge distillation technique is the response-based knowledge distillation technique, the weights adjusting module 210 may calculate distillation loss for the response-based knowledge distillation technique, using at least one of: a cross-entropy loss on the ground-truth labels associated with the training data and Kullback-Leibler (KL) divergence between the predictions from the teacher model and the predictions from the student model. The distillation loss for response-based knowledge distillation may capture the difference between the predictions of the teacher model and the student model, and encourage the student model to not only predict the correct outputs but also to match the soft targets provided by the teacher model. By minimizing this loss function during training, the student model can learn to generalize better and achieve performance similar to, or even surpass, the teacher model. Further, the weights adjusting module 210 may adjust weights of the student model, based on the distillation loss for the response-based knowledge distillation technique.

When the selected knowledge distillation technique is the feature-based knowledge distillation technique, the weights adjusting module 210 may calculate distillation loss for the feature-based knowledge distillation technique, using at least one of: a Euclidean distance or cosine similarity between features of the teacher model and the student model, a mean squared error (MSE) loss, or a correlation alignment loss. The distillation loss for the feature-based knowledge may be defined in various ways, depending on the specific architecture and objectives of the models involved. Further, the weights adjusting module 210 may adjust weights of the student model, based on the distillation loss for feature-based knowledge distillation technique.

When the selected knowledge distillation technique is the relation-based knowledge distillation technique, the weights adjusting module 210 may calculate distillation loss for the relation-based knowledge distillation technique, by minimizing discrepancy between class relationships learned by the teacher model and the student model respectively. The distillation loss for the relation-based knowledge distillation is designed to capture the pairwise relationships between classes, and aims to minimize the discrepancy between the class relationships learned by the teacher model and those learned by the student model. By incorporating this loss term, the student model can effectively capture the intrinsic structure of the data and improve its performance by leveraging the class relationships learned by the teacher model. Further, the weights adjusting module 210 may adjust weights of the student model, based on the distillation loss for feature-based knowledge distillation technique.

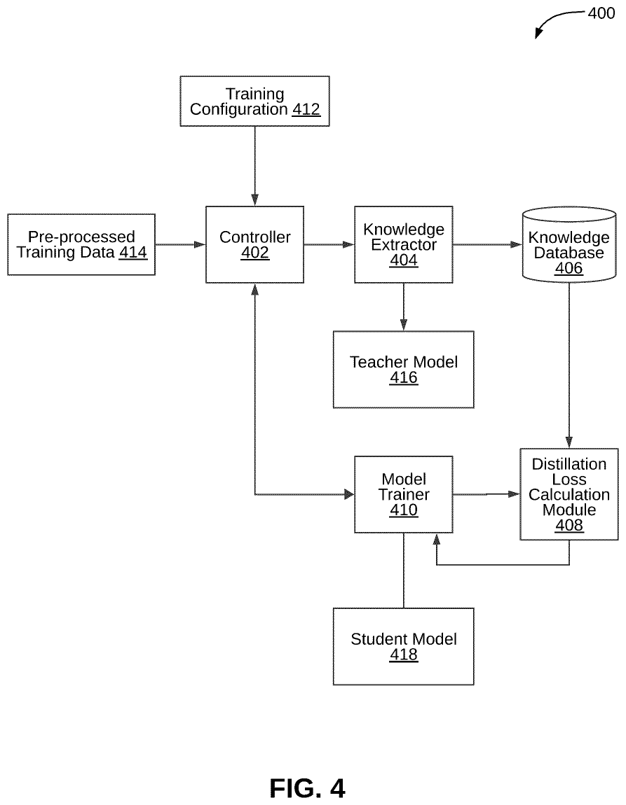

Referring now to FIG. 4, another block diagram representation of a system 400 for training the student model using the teacher model is illustrated, in accordance with some embodiments. The system 400 may include a controller 402, a knowledge extractor 404, a knowledge database 406, a distillation loss calculating module 408, and a model trainer 410.

The controller 402 may be configured to receive training configuration 412 and pre-processed training data 414 (also, referred to as the one or more batches of training data 414).

The training configuration 412 may include a learning rate, a batch size, and an epoch. The one or more batches of training data 414 may include consists of input images along with corresponding target labels (e.g., cat, dog) for classification. Further, the controller 402 may also be configured to receive the selection of the target knowledge distillation technique from the plurality of knowledge distillation techniques, a teacher model 416 (corresponding to the teacher model 118), and a student model 418 (corresponding to the student model 120). The controller 402 may be further configured to determine whether the training data should be fed to the teacher model or the student model to generate the prediction/feature map.

As mentioned above, the teacher model 416 may be a large, computationally expensive neural network that has been trained on a large dataset, and produces accurate predictions but may be slow and resource-intensive. The student model 418 may be a smaller neural network that may be trained using the teacher model 416. The student model 418 may have fewer layers, parameters, or be designed for deployment on less powerful hardware. The aim is to make the student model 418 perform as well as the teacher model 416 while maintaining efficiency. During knowledge distillation, the student model 418 may learn from the teacher model 416 by mimicking its behaviour. In particular, the teacher model's 416 logits (raw output probabilities) may be used as soft targets for the student model 418. The student model 418 may be trained to match these softened logits along with the ground-truth labels from the training data 414.

The controller 402 may first load the teacher model 416 on the memory device. Further, the controller 402 may input each of one or more batches of training data 414 to the knowledge extractor 404 to extract the knowledge output from the teacher model 416. It should be noted that the controller 402 may input each of one or more batches of training data 414 to the knowledge extractor 404 only once. As such, the knowledge extractor may feed the training data to the teacher model 416 only once to generate predictions or feature maps based on the knowledge distillation method, which may be then stored in the knowledge database 406. Subsequently, the controller 402 may iteratively input each of one or more batches of training data 414 to the model trainer 410 to train the student model 418 based on the iteration/epoch specified by the user in the training configuration 412.

The knowledge extractor 404 may extract knowledge output from the teacher model 416 for each of the one or more batches of the training data 414, based on the target (i.e. selected) knowledge distillation technique. The knowledge extractor 404 may extract knowledge output from the teacher model 416 based on the selected knowledge distillation method through a single inference for the one or more batches of the training data 414. Upon extracting, the knowledge extractor 404 may sequentially store the extracted knowledge output in the knowledge database 406. Thereafter, the controller 402 may unload the teacher model 416, and the model trainer 410 may load the student model 418 on the memory device. The model trainer 410 may load the student model 418 for training it for specified a batch of data based on the training configuration 412. In particular, the model trainer 410 may train the student model 418 based on ground-truth labels associated with each of the one or more batches of training data 414 and the knowledge output corresponding to the target knowledge distillation technique. The model trainer 410 may train the student model 418 by fetching the knowledge output corresponding to the target knowledge distillation technique and the specific batch of training data from the knowledge database 406. Therefore, the model trainer 410 may feed the training data into the student model 418 to make predictions or generate feature maps for each iteration based on knowledge distillation technique. Thereafter, weights of the student model 418 may be adjusted based on the distillation loss.

The distillation loss calculation module 408 may calculate the loss between current prediction of the student model 418 and corresponding knowledge output of the teacher model 416 from the knowledge database 406. The distillation loss calculation module 408 may calculate the distillation loss to train the student model 418 using both the true labels (ground-truth labels) and the soft labels (probabilistic outputs) generated by the teacher model 416. This loss helps the student model 418 for faster convergence by capturing the nuanced information that the teacher model 416 has learned. The distillation loss may be a combination of two components: a cross-entropy loss with the ground-truth labels and a Kullback-Leibler (KL) divergence with the soft labels. The cross-entropy loss with ground-truth labels measures the difference between the student model's 418 predictions and the true labels. The KL divergence with soft labels measures the difference between the probability distributions predicted by the teacher model 416 (soft labels) and the student model 418. The soft labels may be generated by applying a temperature scaling to the logits of the teacher model 416, thereby softening the probability distribution. Further, the student model's 418 logits may also be temperature-scaled to produce a softened probability distribution. A total distillation loss is a weighted sum of the cross-entropy loss with the ground-truth labels and the KL divergence with the soft labels.

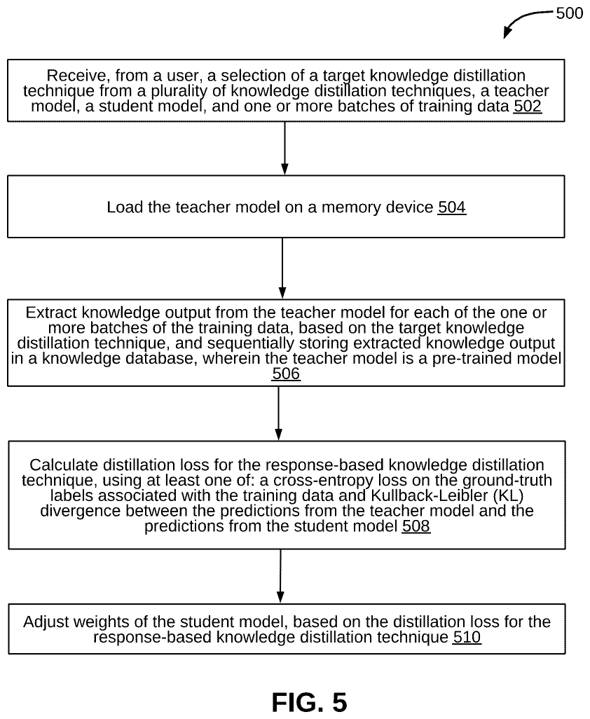

Referring now to FIG. 5, a flowchart of a method 500 of training a student model using a teacher model is illustrated, in accordance with some embodiments. The method 500 may be performed by the model training device 102 of the system 100, as explained above.

At step 502, a selection may be received from a user of a target knowledge distillation technique from the plurality of knowledge distillation techniques, a teacher model, a student model, and one or more batches of training data. The plurality of knowledge distillation techniques may include the response-based knowledge distillation technique, the feature-based knowledge distillation technique, and the relation-based knowledge distillation technique. The teacher model may be a pre-trained model.

At step 504, the teacher model may be loaded on the memory device. At step 506, knowledge output may be extracted from the teacher model for each of the one or more batches of the training data, based on the target knowledge distillation technique. Further, the extracted knowledge output may be sequentially stored in the knowledge database. The knowledge output corresponding to the response-based knowledge distillation technique may include soft targets obtained from a final output layer of the teacher model. The knowledge output corresponding to the feature-based knowledge distillation technique may include internal feature representations obtained from one or more intermediate layers of the teacher model. The knowledge output corresponding to the relation-based knowledge distillation technique may include pair-wise relations and group-wise relations between data points obtained from the teacher model.

At step 508, upon extracting, the teacher model may be unloaded from the memory device and loading the student model on the memory device. At step 510, the student model may be trained based on ground-truth labels associated with each of the one or more batches of training data and the knowledge output corresponding to the target knowledge distillation technique. The student model may be trained by fetching the knowledge output corresponding to the target knowledge distillation technique and each of the one or more batches of training data from the knowledge database.

When the response-based knowledge distillation technique is selected as the target knowledge distillation technique, the method 500 may further include calculating distillation loss for the response-based knowledge distillation technique, using at least one of: a cross-entropy loss on the ground-truth labels associated with the training data and Kullback-Leibler (KL) divergence between the predictions from the teacher model and the predictions from the student model. Further, the method 500 may include adjusting weights of the student model, based on the distillation loss for the response-based knowledge distillation technique.

When the feature-based knowledge distillation technique is selected as the target knowledge distillation technique, the method 500 may further include calculating distillation loss for the feature-based knowledge distillation technique, using at least one of: a Euclidean distance or cosine similarity between features of the teacher model and the student model, a mean squared error (MSE) loss, or a correlation alignment loss. The method 500 may further include adjusting weights of the student model, based on the distillation loss for feature-based knowledge distillation technique.

When the relation-based knowledge distillation technique is selected as the target knowledge distillation technique, the method 500 may further include calculating distillation loss for the relation-based knowledge distillation technique, by minimizing discrepancy between class relationships learned by the teacher model and the student model respectively. The method may further include adjusting weights of the student model, based on the distillation loss for feature-based knowledge distillation technique.

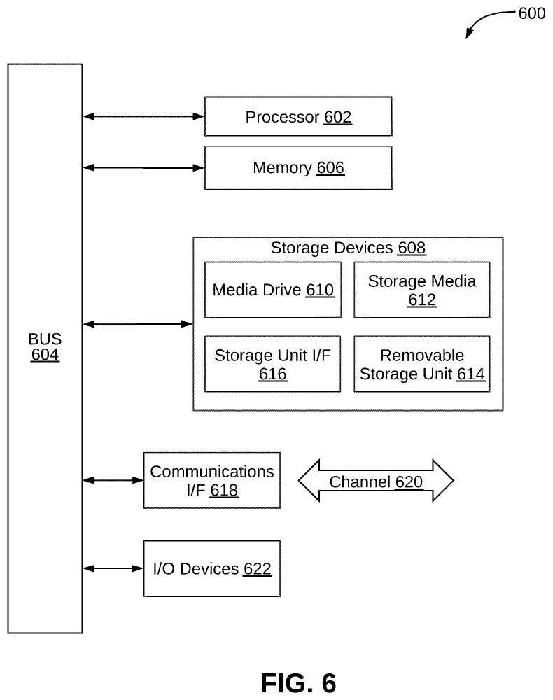

Referring now to FIG. 6, an exemplary computing system 600 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 600 may represent, for example, a user device such as a desktop, a laptop, a mobile phone, personal entertainment device, DVR, and so on, or any other type of special or general-purpose computing device as may be desirable or appropriate for a given application or environment. The computing system 600 may include one or more processors, such as a processor 602 that may be implemented using a general or special purpose processing engine such as, for example, a microprocessor, microcontroller or other control logic. In this example, the processor 602 is connected to a bus 604 or other communication media. In some embodiments, the processor 602 may be an Artificial Intelligence (AI) processor, which may be implemented as a Tensor Processing Unit (TPU), or a graphical processor unit, or a custom programmable solution Field-Programmable Gate Array (FPGA).

The computing system 600 may also include a memory 606 (main memory), for example, Random Access Memory (RAM) or other dynamic memory, for storing information and instructions to be executed by the processor 602. The memory 606 also may be used for storing temporary variables or other intermediate information during the execution of instructions to be executed by processor 602. The computing system 600 may likewise include a read-only memory (“ROM”) or other static storage device coupled to bus 604 for storing static information and instructions for the processor 602.

The computing system 600 may also include storage devices 608, which may include, for example, a media drive 610 and a removable storage interface. The media drive 610 may include a drive or other mechanism to support fixed or removable storage media, such as a hard disk drive, a floppy disk drive, a magnetic tape drive, an SD card port, a USB port, a micro-USB, an optical disk drive, a CD or DVD drive (R or RW), or other removable or fixed media drive. A storage media 612 may include, for example, a hard disk, magnetic tape, flash drive, or other fixed or removable media that is read by and written to by the media drive 610. As these examples illustrate, the storage media 612 may include a computer-readable storage medium having stored therein particular computer software or data.

In alternative embodiments, the storage devices 608 may include other similar instrumentalities for allowing computer programs or other instructions or data to be loaded into the computing system 600. Such instrumentalities may include, for example, a removable storage unit 614 and a storage unit interface 616, such as a program cartridge and cartridge interface, a removable memory (for example, a flash memory or other removable memory module) and memory slot, and other removable storage units and interfaces that allow software and data to be transferred from the removable storage unit 614 to the computing system 600.

The computing system 600 may also include a communications interface 618. The communications interface 618 may be used to allow software and data to be transferred between the computing system 600 and external devices. Examples of the communications interface 618 may include a network interface (such as an Ethernet or other NIC card), a communications port (such as for example, a USB port, a micro-USB port), Near field Communication (NFC), etc. Software and data transferred via the communications interface 618 are in the form of signals which may be electronic, electromagnetic, optical, or other signals capable of being received by the communications interface 618. These signals are provided to the communications interface 618 via a channel 620. The channel 620 may carry signals and may be implemented using a wireless medium, wire or cable, fiber optics, or other communications medium. Some examples of the channel 620 may include a phone line, a cellular phone link, an RF link, a Bluetooth link, a network interface, a local or wide area network, and other communications channels.

The computing system 600 may further include Input/Output (I/O) devices 622. Examples may include, but are not limited to a display, keypad, microphone, audio speakers, vibrating motor, LED lights, etc. The I/O devices 622 may receive input from a user and also display an output of the computation performed by the processor 602. In this document, the terms “computer program product” and “computer-readable medium” may be used generally to refer to media such as, for example, the memory 606, the storage devices 608, the removable storage unit 614, or signal(s) on the channel 620. These and other forms of computer-readable media may be involved in providing one or more sequences of one or more instructions to the processor 602 for execution. Such instructions, generally referred to as “computer program code” (which may be grouped in the form of computer programs or other groupings), when executed, enable the computing system 600 to perform features or functions of embodiments of the present invention.

In an embodiment where the elements are implemented using software, the software may be stored in a computer-readable medium and loaded into the computing system 600 using, for example, the removable storage unit 614, the media drive 610 or the communications interface 618. The control logic (in this example, software instructions or computer program code), when executed by the processor 602, causes the processor 602 to perform the functions of the invention as described herein.

One or more techniques for training a student model using a teacher model are disclosed. The techniques provide for sequential and independent extraction of knowledge from the teacher model and injecting into the student model. the sequential and single inference of the teacher model reduced the computational requirement, thereby making the training process more efficient. The techniques allow for the knowledge extraction from the teacher model to be performed in the cloud or on high-end hardware when the model is too complex. Furthermore, the techniques allow for the student model training to be performed using a knowledge database without keeping the teacher model live. This enables the knowledge distillation-based training on resource constrained device.

It is intended that the disclosure and examples be considered as exemplary only, with a true scope and spirit of disclosed embodiments being indicated by the following claims.

What is claimed is:

1. A method of training a student model using a teacher model, the method comprising:
receiving, from a user, a selection of a target knowledge distillation technique from a plurality of knowledge distillation techniques, a teacher model, a student model, and one or more batches of training data;
loading the teacher model on a memory device;
extracting knowledge output from the teacher model for each of the one or more batches of the training data, based on the target knowledge distillation technique, and sequentially storing extracted knowledge output in a knowledge database, wherein the teacher model is a pre-trained model;
Upon extracting, unloading the teacher model from the memory device and loading the student model on the memory device; and
training the student model based on ground-truth labels associated with each of the one or more batches of training data and the knowledge output corresponding to the target knowledge distillation technique, by fetching the knowledge output corresponding to the target knowledge distillation technique and each of the one or more batches of training data from the knowledge database.

2. The method of claim 1, wherein the plurality of knowledge distillation techniques comprises: a response-based knowledge distillation technique, a feature-based knowledge distillation technique, and a relation-based knowledge distillation technique.

3. The method of claim 2, wherein the knowledge output corresponding to the response-based knowledge distillation technique comprises soft targets obtained from a final output layer of the teacher model.

4. The method of claim 3 further comprising:
calculating distillation loss for the response-based knowledge distillation technique, using at least one of: a cross-entropy loss on the ground-truth labels associated with the training data and Kullback-Leibler (KL) divergence between the predictions from the teacher model and the predictions from the student model; and
adjusting weights of the student model, based on the distillation loss for the response-based knowledge distillation technique.

5. The method of claim 2, wherein the knowledge output corresponding to the feature-based knowledge distillation technique comprises internal feature representations obtained from one or more intermediate layers of the teacher model.

6. The method of claim 5 further comprising:
calculating distillation loss for the feature-based knowledge distillation technique, using at least one of: a Euclidean distance or cosine similarity between features of the teacher model and the student model, a mean squared error (MSE) loss, or a correlation alignment loss; and
adjusting weights of the student model, based on the distillation loss for feature-based knowledge distillation technique.

7. The method of claim 2, wherein the knowledge output corresponding to the relation-based knowledge distillation technique comprises pair-wise relations and group-wise relations between data points obtained from the teacher model.

8. The method of claim 2 further comprising:
calculating distillation loss for the relation-based knowledge distillation technique, by minimizing discrepancy between class relationships learned by the teacher model and the student model respectively; and
adjusting weights of the student model, based on the distillation loss for feature-based knowledge distillation technique.

9. The method of claim 1, wherein training the student model comprises: iteratively inputting each of the one or more batches of training data to the student model based on a predefined epoch.

10. A system for training a student model using a teacher model, the system comprising:
a processor; and
a memory communicatively coupled to the processor, the memory storing a plurality of processor-executable instructions, wherein the processor-executable instructions, upon execution by the processor, cause the processor to:
receive, from a user, a selection of a target knowledge distillation technique from a plurality of knowledge distillation techniques, a teacher model, a student model, and one or more batches of training data;
load the teacher model on a memory device;
extract knowledge output from the teacher model for each of the one or more batches of the training data, based on the target knowledge distillation technique, and sequentially storing extracted knowledge output in a knowledge database, wherein the teacher model is a pre-trained model;
upon extracting, unload the teacher model from the memory device and loading the student model on the memory device; and
train the student model based on ground-truth labels associated with each of the one or more batches of training data and the knowledge output corresponding to the target knowledge distillation technique, by fetching the knowledge output corresponding to the target knowledge distillation technique and each of the one or more batches of training data from the knowledge database.

11. The system of claim 10, wherein the plurality of knowledge distillation techniques comprises: a response-based knowledge distillation technique, a feature-based knowledge distillation technique, and a relation-based knowledge distillation technique.

12. The system of claim 11, wherein the knowledge output corresponding to the response-based knowledge distillation technique comprise soft targets obtained from a final output layer of the teacher model, and wherein the processor-executable instructions further cause the processor to:
calculate distillation loss for the response-based knowledge distillation technique, using at least one of: a cross-entropy loss on the ground-truth labels associated with the training data and Kullback-Leibler (KL) divergence between the predictions from the teacher model and the predictions from the student model; and
adjust weights of the student model, based on the distillation loss for the response-based knowledge distillation technique.

13. The system of claim 11, wherein the knowledge output corresponding to the feature-based knowledge distillation technique comprises internal feature representations obtained from one or more intermediate layers of the teacher model, and wherein the processor-executable instructions further cause the processor to:
calculate distillation loss for the feature-based knowledge distillation technique, using at least one of: a Euclidean distance or cosine similarity between features of the teacher model and the student model, a mean squared error (MSE) loss, or a correlation alignment loss; and
adjust weights of the student model, based on the distillation loss for feature-based knowledge distillation technique.

14. The system of claim 11, wherein the knowledge output corresponding to the relation-based knowledge distillation technique comprises pair-wise relations and group-wise relations between data points obtained from the teacher model, and wherein the processor-executable instructions further cause the processor to:
calculate distillation loss for the relation-based knowledge distillation technique, by minimizing discrepancy between class relationships learned by the teacher model and the student model respectively; and
adjust weights of the student model, based on the distillation loss for feature-based knowledge distillation technique.

15. The system of claim 10, wherein training the student model comprises: iteratively inputting each of the one or more batches of training data to the student model based on a predefined epoch.

16. A non-transitory computer-readable medium storing computer-executable instructions for training a student model using a teacher mode, the computer-executable instructions configured for:
receiving, from a user, a selection of a target knowledge distillation technique from a plurality of knowledge distillation techniques, a teacher model, a student model, and one or more batches of training data;
loading the teacher model on a memory device;
extracting knowledge output from the teacher model for each of the one or more batches of the training data, based on the target knowledge distillation technique, and sequentially storing extracted knowledge output in a knowledge database, wherein the teacher model is a pre-trained model;
Upon extracting, unloading the teacher model from the memory device and loading the student model on the memory device; and
training the student model based on ground-truth labels associated with each of the one or more batches of training data and the knowledge output corresponding to the target knowledge distillation technique, by fetching the knowledge output corresponding to the target knowledge distillation technique and each of the one or more batches of training data from the knowledge database.

17. The non-transitory computer-readable medium of claim 16, wherein the plurality of knowledge distillation techniques comprises: a response-based knowledge distillation technique, a feature-based knowledge distillation technique, and a relation-based knowledge distillation technique.

18. The non-transitory computer-readable medium of claim 17, wherein the knowledge output corresponding to the response-based knowledge distillation technique comprises soft targets obtained from a final output layer of the teacher model.

19. The non-transitory computer-readable medium of claim 18, wherein the computer-executable instructions are further configured for:
calculating distillation loss for the response-based knowledge distillation technique, using at least one of: a cross-entropy loss on the ground-truth labels associated with the training data and Kullback-Leibler (KL) divergence between the predictions from the teacher model and the predictions from the student model; and
adjusting weights of the student model, based on the distillation loss for the response-based knowledge distillation technique.

20. The non-transitory computer-readable medium of claim 17, wherein the knowledge output corresponding to the feature-based knowledge distillation technique comprises internal feature representations obtained from one or more intermediate layers of the teacher model.
